(19) United States
(12) Patent Application Publication
(10) Pub. No.: US 2009/0235159 A1
(43) Pub. Date: Sep. 17, 2009

(54) HTML MAIL MAKING SYSTEM, HTML MAIL MAKING METHOD, PROGRAM THEREOF AND PROGRAM RECORDING MEDIUM

(76) Inventor: HIRONORI HOSODA, Kanagawa (JP)

Correspondence Address: NEC CORPORATION OF AMERICA, 6535 N. STATE HWY 161, IRVING, TX, 75039, US

(21) Appl. No.: 12/403,016

(22) Filed: Mar. 12, 2009

(30) Foreign Application Priority Data
Mar. 17, 2008 (JP) 066966/2008

(51) Int. Cl. G06F 17/00; G06F 15/16

(52) U.S. Cl. 715/235; 709/206

(57) ABSTRACT

An HTML mail making system is capable of making an outgoing HTML mails having the style in compliance with the company's CI policy. For this end, an access is made to the company's home page (Web page) that strictly sets the style of HTML mails in compliance with the company's CI policy. A CSS definition syntax that defines the style of the home page is acquired for applying it to the style of HTML mails to be made. A predetermined standard template is applied to the style of HTML mails if the CSS definition syntax does not exist or if failed in acquiring it. The CSS definition syntax relating to the style of the home page is acquired and stored periodically at a predetermined period and the stored CSS definition syntax is applied to the style of HTML mails to be made.

### INCORPORATION BY REFERENCE

This application is based upon and claims the benefit of priority from Japanese patent application no. 2008-066966, the disclosure of which is incorporated herein in its entirety by reference.

### TECHNICAL FIELD

This invention relates to an HTML mail making system, an HTML mail making method, a program thereof and a program recording medium.

### BACKGROUND ART

Recently, as a result of development of internet technologies, it becomes common to make documents using a markup language such as, for example, an Hypertext Markup Language (referred to as an HTML language below), an Extensible Markup Language (an EML language), etc. The use of the markup language enables to improve retrieval and readability of documents to be made because of the capability of burying meaningful information in such documents and of burying such information as layout, modifications and the like when displaying or printing such documents.

Moreover, separating from the HTML language that describes contents of documents, defined is a style description language such as CSS (Cascading Style Sheets) for enabling to define display layouts, character modifications and the like of HTML documents. By defining the style sheets that describe layout information using the CSS by separating from the HTML language that describes the contents of documents, it is also possible to manage the contents of documents independently from the display layouts.

Proposed in Japanese patent publication JP2003-330915A entitled “Style Sheet Processing Apparatus” is an optimizing technology for independently analyzing the contents of style sheets that are described using the CSS and suppressing the reduction of processing speed when displaying or printing.

On the other hand, as a result of popularization of internet, the use of e-mails is increasing popular in modern company activities such as sales promotion advertisements and the like. In this case, for improving understandability, retrievable function or the like of the contents of the outgoing e-mails, i.e., those to be sent outside the company, the format of e-mails generally uses HTML mails to which the HTML format is applied.

It is preferable that the display style of HTML mails for such company activities reflects the company's identity or image. However, it is the current situation that such mails are permitted to make by each employee's own judgment. As a result, HTML mails made by different employees in a company vary in the layout or style one another, thereby threatening to damage the company's CI (Corporate Identity) policy.

Furthermore, there is no sign or movement so far of applying the style sheets by the CSS to layout information of HTML mails.

### SUMMARY

In light of the foregoing circumstances, it is an exemplary object of the invention to provide an HTML mail making system, an HTML mail making method, an HTML mail making program and a program recording medium in which the style of an outgoing HTML mail is set to the style sheets by the CSS. The style sheets are set using the style sheets that are adapted by the company's CI policy, thereby enabling all employees to make HTML mails in compliance with the company's CI policy or strategy.

In order to achieve the above exemplary object, the HTML mail making system, the HTML mail making method, the HTML mail making program and the program recording medium according to the invention employ the following unique constructions:

(1) An HTML mail making system for making an HTML mail using an HTML language according to an exemplary embodiment of the invention includes access to a predetermined Web page for acquiring CSS (Cascading Style Sheets) definition syntax that defines the style of the Web page and application of the acquired CSS definition syntax to the style of the HTML mail to be made.

The HTML mail making system, the HTML mail making method, the HTML mail making program and the program recording medium according to exemplary embodiments of the invention exhibit various practical advantages as follows:

An exemplary advantage according to the invention is the capability of making an outgoing HTML mail having an appearance (or style) in compliance with the company's CI policy without additional new investment at the server side. Because an access is made to the company's home page as a predetermined Web page and the appearance on the display screen of the home page (Web page) that is generally designed with finest care in compliance with the company's CI policy is adapted to the appearance of the HTML mail to be made without any modification.

Another exemplary advantage according to the invention is to reduce appearance design works of outgoing mails by the mail making employee (user). Because the CSS definition syntax for making HTML mails is acquired automatically, thereby eliminating the need for the mail making employee (user) to involve in the CSS design for the HTML mails.

A still another exemplary advantage according to the invention is to overcome variations in appearance of outgoing HTML mails to be made by different employees (users). Because the CSS definition syntax that defines the style of the home page (Web page) is extracted from the same Web page or the home page (Web page) for disclosing outside the company or the standard template that is predetermined as default is employed for setting the style of the HTML mails, thereby enabling all employees (users) to make HTML mails having a common appearance.

A yet another exemplary advantage according to the invention is the flexibility to changes in the company's brand image strategy or CI policy. Because the CSS acquisition means that is an essential part of the invention gains access to the company's home page (Web page) whenever a new HTML mail is to be made for extracting the updated CSS definition syntax that defines the most recent style or stores the CSS definition syntax of the company's home page that is acquired as a result of periodic accesses to the company's home page for use the stored most recent CSS definition syntax when a new HTML mail is to be made, thereby enabling to set the appearance of the HTML mail in compliance with the company's updated CI policy.

### BRIEF DESCRIPTION OF THE DRAWINGS

The above and other exemplary advantages according to the invention will become apparent by reading the following detailed descriptions of exemplary embodiments of the invention with reference to the accompanying drawings, wherein:

FIG. 1 is an illustration to describe an exemplary configuration of the HTML mail making system according to the invention;

FIG. 2 is the entire system configuration of an example of the HTML mail making system according to the invention;

FIG. 3 is a connection diagram of one example of connecting the PC in FIG. 2 with external equipment;

FIG. 4 is a block diagram to show an exemplified internal construction of the PC as shown in FIG. 2;

FIG. 5 is an exemplified construction of the HTML mail making program according to the invention;

FIG. 6 is a flowchart to illustrate an exemplified operation of the CSS acquisition means as shown in FIG. 5 when making a new HTML mail; and

FIG. 7 is a flowchart to illustrate an exemplified operation of the CSS acquisition means as shown in FIG. 5 when making a new HTML mail but different from the one in FIG. 6.

### EXEMPLARY EMBODIMENTS

Now, exemplary embodiments of an HTML mail making system, an HTML mail making method, an HTML mail making program and a program recording medium according to the invention will be described with reference to the accompanying drawings. Although the HTML mail making system and the HTML mail making method will be described hereinafter, needless to say that the HTML mail making method according to the invention can be implemented as an HTML mail making program in a manner to be executed by a computer and the HTML mail making program can be recorded in a computer readable recording medium.

### (Features of the Invention)

Prior to detailed descriptions of exemplary embodiments of the invention, an overview of features of the invention is given hereunder. The invention features in describing layout information or a style to be used in a home page (Web page) that is disclosed outside the company about company related information as style sheets using the CSS (Cascading Style Sheets). When making a new HTML mail for disclosing outside the company, extracted are the CSS data or the style sheets for the Web home page before making the outgoing HTML mail that automatically reflects the definition information of the style sheets.

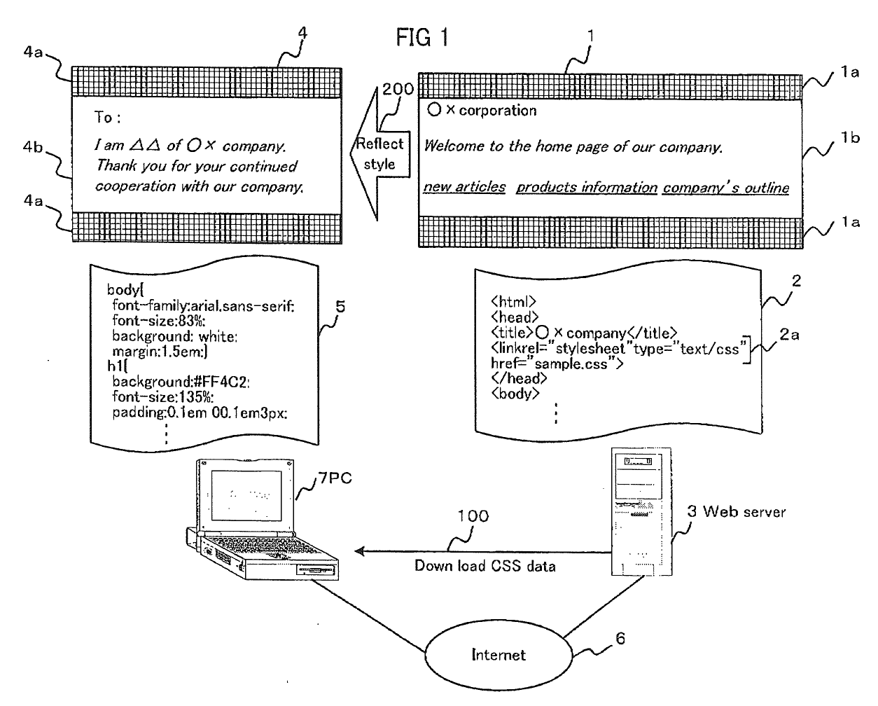

In other words, the style that is strictly in compliance with the company's CI policy representing the company image is generally set as the layout information or the style of the home page (Web page) for disclosing any company information on the internet. As a result, it is preferable that any outgoing company information follows the exact layouts that are set as the styles of the company's home page. Further descriptions of applying this system to outgoing HTML mails will be made with reference to the illustration in FIG. 1. FIG. 1 is the illustration for describing the HTML mail making system according to the invention.

In FIG. 1, a reference numeral 1 represents a home page display screen that illustrates an image on the screen display of the company's home page that is designed to disclose outside the company. A reference numeral 2 represents HTML sentences for home page that illustrate source codes for displaying the home page display screen 1. A reference numeral 3 represents a Web server that stores the HTML sentences for home page 2. The HTML sentences for home page 2 stored in the Web server 3 contain style sheets definition reference codes 2a that use the CSS (Cascading Style Sheets).

When gaining access to the Web server 3 by way of the internet 6 for requesting to display the home page, a grid pattern la will be displayed at both top and bottom portions on the screen in accordance with a reference result of the style sheets definition reference codes 2a as shown in the home page display screen 1. Also displayed at the predetermined center portion of the screen are designated font, size and color text information 1b on a plain background.

When making a new outgoing HTML mail using a PC 7, an operator who makes the mail gains access to the Web server 3 by way of, for example, the internet 6 and down loads in the PC 7 CSS data 5 that are referred from the style sheets definition reference codes 2a contained in the HTML sentences for the company's home page 2 as indicated by an arrow 100. As a result, the down loaded CSS data 5 are taken in the style sheets for making a new HTML mail and are displayed on the screen of the PC 7 as a new HTML mail making screen 4 in the format that directly reflects the style of the home page display screen 1 without making any changes as indicated by an arrow 200.

In other words, a grid pattern 4a designated in the CSS data that are referred from the style sheets definition reference codes 2a is displayed at both top and bottom portions on the HTML mail making screen 4. Also displayed at the center portion on the screen on a plain background is mail body information 4b that represents the font, size and color of the mail body designated by the CSS data 5 that are referred from the style sheets definition reference codes 2a.

### Configuration of Exemplary Embodiment

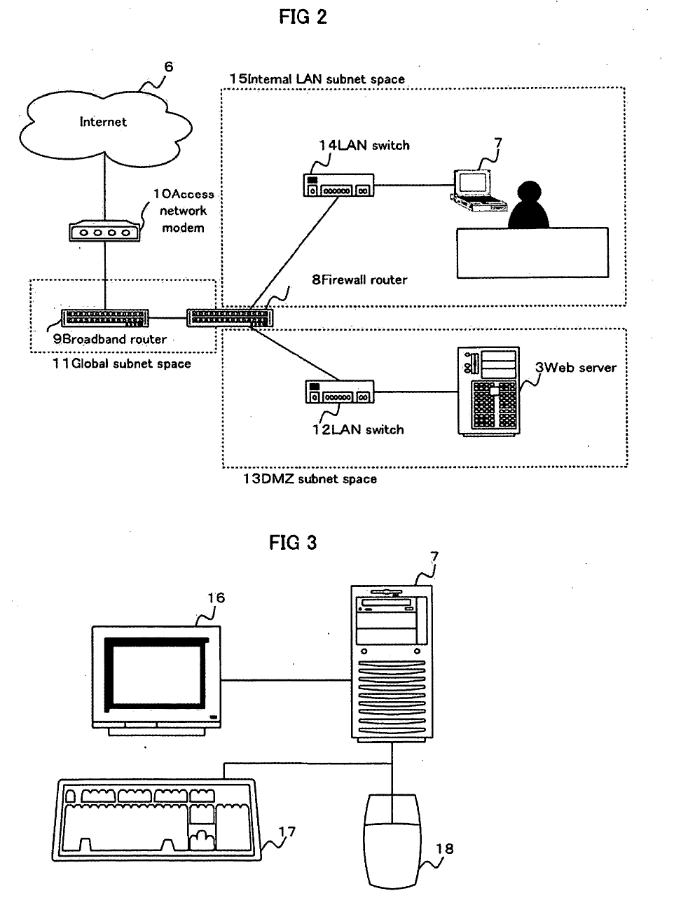

Now, a configuration of an exemplary HTML mail making system according to the invention will be described in greater detail with reference to the accompanying drawings. FIG. 2 illustrates an exemplified entire system configuration of the HTML mail making system according to the invention. The exemplary embodiment of the HTML mail making system as shown in FIG. 2 is a case installed in a company. The Web server 3 exposed outside the company and the PC 7 to be used by a company's employee are connected to a firewall router 8 respectively by way of LAN switches 12 and 14 and then to the internet 6 by way of a broadband router 9 and an access network modem 10.

As shown in FIG. 2, the broadband router 9 and the access network modem 10 are first required in order to enable the connection of the Web server 3 and the PC 7 to the internet 6. Moreover, in order to make the Web server 3 available to public outside the company, the firewall router 8 is installed and a predetermined number of global IP (Internet Protocol) addresses are provided from an ISP (Internet Service Provider), thereby configuring a global subnet space 11 between the broadband router 9 and the firewall router 8.

Subsequently, a DMZ (De-Militarized Zone) subnet space 13 is configured between the firewall router 8 and the Web server 3 in order to provide a Web server public network for disclosing outside the company. Moreover, it is preferable that the DMZ sub-net space 13 uses a quarantine function and a static NAT (Network Address Translator) function of the firewall router 8 for protecting direct access from the internet 6 and saving global IP addresses.

Finally, in order to provide an internal private network, an internal LAN subnet space 15 is configured between the firewall router 8 and the employee's PC 7. It is also preferable that the internal LAN subnet space 15 uses a dynamic or static NAT function of the firewall router 8 for enabling the employee's PC 7 to gain access to the internet 6.

Now, external equipment to be connected to the employee's PC 7 will be described with reference to FIG. 3. FIG. 3 is an exemplary connection diagram of external equipment to be connected to the PC 7 in FIG. 2. As shown in FIG. 3, connected to the PC 7 to be used by an employee (user) for making HTML mails are at least a display unit 16 for providing a screen display, a keyboard 17 and a mouse 18 as input devices for an employee (user).

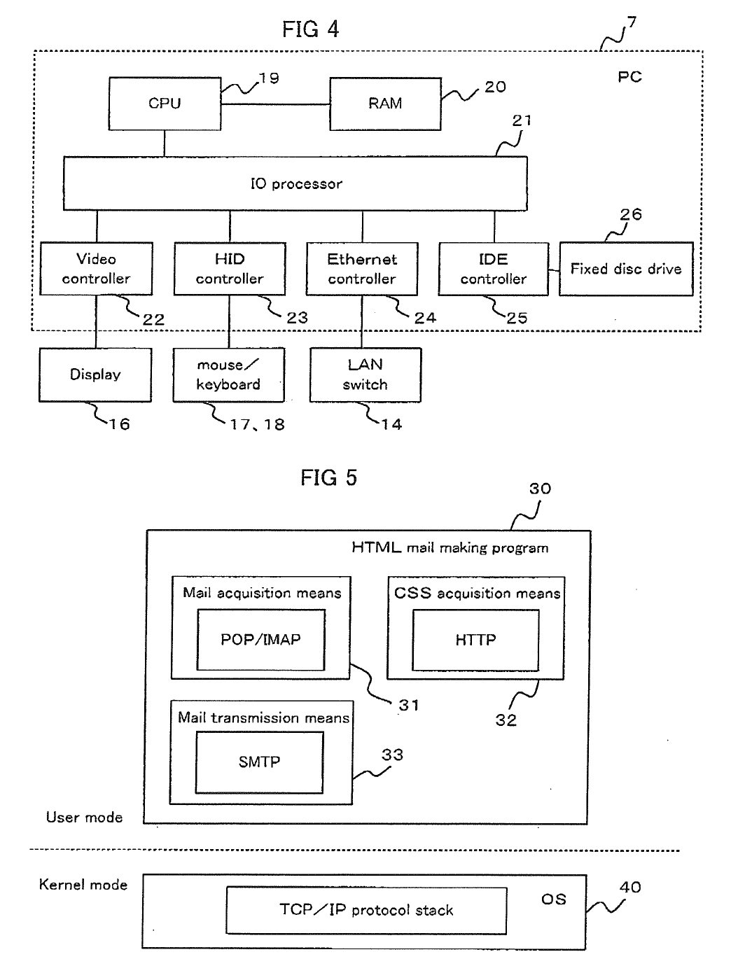

Now, an internal construction of the employee's PC 7 will be described with reference to FIG. 4 that is an exemplary block diagram illustrating the internal construction of the employee's PC 7 as shown in FIG. 2. As shown in FIG. 4, the PC 7 to be used by an employee (user) for making HTML mails has the same construction as a normal PC (Personal Computer) and comprises at least a CPU 19, a RAM 20, an IC processor 21, a video controller 22, an HID controller 23, an Ethernet controller 24, an IDE controller 25 and a fixed disc drive 26.

The CPU 19 cooperates with the RAM 20 that is a main storage device and the IO processor 21 that controls the operation of IO (Input and Output) devices for controlling the entire operations of the PC 7 such as operations of programs, controls of peripheral equipments, etc. The RAM 20 that is a main storage device provides a memory space to which the CPU 19 gains access either randomly or directly for temporarily storing data for various arithmetic calculations or loading various program codes saved in the fixed disc drive 26 prior to execution of instructions.

The IO processor 21 plays a roll to send control instructions to the group of HW (hardware) such as the video controller 22, the HID controller 23, Ethernet controller 24, the IDE controller 25 and the like and also interrupt signals to the CPU 19. The video controller 22 is a unit for controlling screen display operations on the display unit 16. The HID controller 23 is a unit for processing inputs from the keyboard 17 and the mouse 18. The Ethernet controller 24 is a unit for controlling data transmission and receiving operations to and from the LAN switch 14. The IDE controller 25 is a unit for controlling data transmission and receiving operations to and from the fixed disc drive 26.

Now, description will be made with reference to FIG. 5 on the structure of the exemplary HTML mail making program according to the invention that is stored in the fixed disc drive 26 and loaded in the RAM 20 for execution when needed. FIG. 5 illustrates a program structure of the exemplary HTML mail making program according to the invention. It illustrates the structure of the exemplary HTML mail making program when the HTML mail making method according to the invention is implemented in form of a program. In other words, the HTML mail making method according to the present invention may be implemented in the program logic as shown in FIG. 5. Alternatively, at least a part of the functions as shown in FIG. 5 may be implemented in firmware logics or hardware logics.

As shown in FIG. 5, the exemplary HTML mail making program 30 is one of application groups to be placed on the existing OS (Operating System) 40 having a TCP/IP (Transmission Control Protocol/Internet Protocol) stack. The OS 40 operates in a kernel mode, but the HTML mail making program 30 operates in a user mode having a low authority.

The HTML mail making program 30 is provided with mail acquisition means 31, CSS acquisition means 32 and mail transmission means 33 that are respectively processed using a POP/IMAP (Post Office Protocol/Internet Message Access Protocol), an HTTP (Hypertext Transfer Protocol) and an SMTP (Simple Mail Transfer Protocol) all of which are known protocols for internet.

### Operation of Exemplary Embodiment

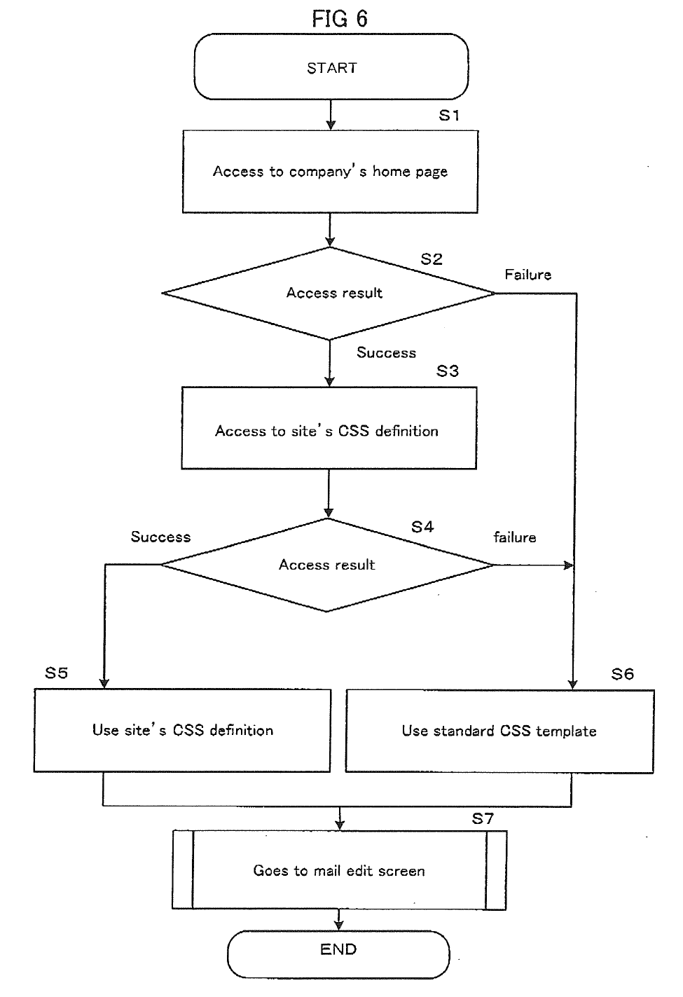

Now, a description will be made with reference to the flowchart in FIG. 6 on the operation of the exemplary HTML mail making system according to the invention as shown in FIGS. 1 through 5. An example of processing to be performed by the CSS acquisition means 32 when making a new HTML mail will be described in greater detail with reference to the flowchart in FIG. 6 as a characteristic operation in the exemplary HTML mail making system according to the invention. FIG. 6 is an exemplified flowchart illustrating the operation of the CSS acquisition means 32 in FIG. 5 when making a new HTML mail.

In FIG. 6, a first step is to gain access to the company's Web server 3 for attempting to acquire the company's home page (Web page) by way of the HTTP protocol (step S1). If failed to gain access to the company's home page at this time (“Failure” in step S2), it is obvious that the extraction processing of the CSS data is failed, i.e., the extraction processing of the information about the style of the company's home page is not successful. The extraction processing of the CSS definition syntax is skipped and the processing jumps to step S6 for performing a default processing that uses a standard template as the style of the HTML mail.

On the other hand, if the access to the company's home page is successful (“Success” in step S2), an attempt is made to extract the CSS definition syntax that defines the style of writing the company's home page (Web page) (step S3). If successful in extracting the CSS definition syntax that defines the style of writing the company's home page (Web page) (“Success” in step S4), the contents of the CSS definition syntax that defines the style of writing the company's home page (Web page) are applied to the style sheets for making a new mail (step S5).

It is to be noted here that the CSS definition syntax that defines the style of the home page (Web page) contain both of patterns for direct description of the CSS definition syntax on the home page (Web page) and patterns for saving documents of independent CSS definition syntax on a separate Web page as illustrated in FIG. 1 and for performing a URL (Uniform Resource Locator) link from the home page to the Web page in which the documents for the CSS definition sentences are saved. In the former case, extracted are codes for the CSS definition syntax existing on the home page (Web page). On the other hand, in the latter case, extracted are codes for the CSS definition syntax existing on the documents in the home page (Web page) to be linked by the URL.

If there are no CSS definition syntax on the home page (Web page) or if failed to gain access to the documents to be linked by the URL (i.e., “Failure” in step S4), a processing is performed to employ the standard template that is preset in case of default as the style for making a new mail (step S6).

Subsequently, performed is the processing for displaying the CSS definition syntax that defines the style of writing the home page employed in step S5 of the standard template employed in step S6 as the HTML mail editing screen that reflects the new mail writing style, thereby enabling to make the body of the mail by a company's mail making employee (user) or to transmit the mail that is made. As a result, all outgoing HTML mails that are made by the mail making employee (user) for disclosing outside the company are guaranteed to comply with the style of the CI policy of the company for which the employee works.

### Advantages of Exemplary Embodiment

As understood from the above descriptions, the exemplary embodiment of the HTML mail making system according to the invention exhibits various advantages as described hereunder.

An exemplary advantage according to the invention is the capability of making HTML mails to be disclosed outside the company having the appearance (or style) in perfect compliance with the established company's CI policy without the need for additional new investments at the server side. Because access to the company's home page for disclosing outside the company as the predetermined Web page ensures to inherit in the appearance of HTML mails that of the home page (Web page) screen display, i.e., the home page screen display 1 as shown in FIG. 1 that is normally designed in strict compliance with the company's CI policy. Additionally, processing in this exemplary embodiment is concluded at the client side, thereby not requiring any additional investments for new installation or maintenance of CSS information notification server and the like that uses, for example, RSS (RDF Site Summary) technology.

Another exemplary advantage according to the invention is to release the mail making employee (user) from appearance design works for outgoing HTML mails. Because the CSS definition syntax for making HTML mails are automatically acquired by the CSS acquisition means 32 that is one of essential features of the invention as shown in FIG. 5 when performing step S7, i.e., the new HTML mail making step as shown in FIG. 6, thereby eliminating the need for the mail making employee (user) to be involved in the CSS design for the HTML mails.

A still another exemplary advantage according to the invention is to eliminate any variation in appearance of outgoing HTML mails made by different mail making employees (users). Because the CSS acquisition means 32 that is shown in FIG. 5 and is an essential feature of the invention extracts the CSS definition syntax that defines the style of the home page (Web page) from the same Web page or the home page (Web page) for disclosing outside the company or alternatively employ the standard template that is prepared in advance for default, thereby setting the style of outgoing HTML mails. This means that all HTML mails made by different mail making employees have the common appearance.

A yet another exemplary advantage according to the invention is to provide flexibility to adapt to any changes and modifications of the company's brand image or the company's CI policy. Because the CSS acquisition means 32 that is shown in FIG. 5 and is an essential feature of the invention gains access to the company's home page (Web page) whenever a new HTML mail is made, thereby enabling to extract the updated CSS definition syntax that defines the most recent style. This mean s that the appearance of the outgoing HTML mails is set in compliance with the most recently updated CI policy.

### Descriptions of Operation of Another Exemplary Embodiment

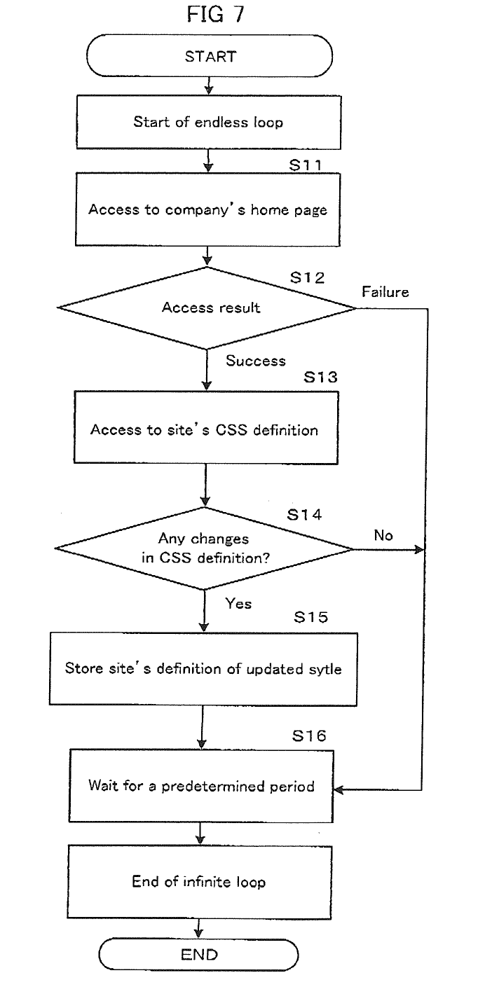

Now, exemplified operations different from the flowchart as shown in FIG. 6 of the HTML mail making system as shown in FIGS. 1-5 will be given hereunder with reference to the flowchart in FIG. 7. In FIG. 7, processing to be performed by the CSS acquisition means 32 that automatically acquires the CSS data for defining the style of the HTML mails also follows the featuring operations of the HTML mail making system according to the invention. Accordingly, differences in operations from those in the flowchart in FIG. 6 will be described in greater detail hereunder. FIG. 7 is an exemplified flowchart illustrating operations of the CSS acquisition means 32 in FIG. 5 when making a new HTML mail but different from the flowchart in FIG. 6.

Different from the case as shown in FIG. 6, the operation as shown in FIG. 7 is not initiated at the time of making a new mail. Instead, it features to be performed on a background basis as an endless loop operation for continuously monitoring any change in CSS definition conditions.

In FIG. 7, a first step is to gain access to the company's Web server 3 for attempting to acquire the company's home page (Web page) by way of the HTTP protocol (step S11). If failed to gain access the company's home page at this time (i.e., “Failure” in step S12), it is obviously impossible to perform the extraction processing of the CSS data, i.e., information relating to the style of the company's home page. Thus, the extraction processing of CSS definition syntax is skipped and the processing jumps to step S16 to wait for a predetermined time.

On the contrary, if the access to the company's home page is successful (i.e., “Success” in step S12), an attempt is made to extract the CSS definition syntax that defines the style of writing the company's home page (Web page) (step S13). If succeeded in extracting the CSS definition syntax that defines the style of writing the company's home page (Web page), it is checked if the extracted CSS definition syntax changed from the previously extracted CSS definition syntax (step S14). If the extracted CSS definition syntax is the same as the previous one, i.e., no changes are found (“No” in step S14), it is instructed to wait for a predetermined time (step S16).

On the contrary to the above case, if it is found that the extracted CSS definition syntax is different from the previously extracted one (“Yes” in step S14), the newly extracted CSS definition syntax is stored as information defining the updated style in a predetermined storage area in the fixed disc drive 26 (step S15). It is to be noted in case of performing the operation as illustrated in the flowchart in FIG. 7 that information relating to the CSS definition syntax as stored in the predetermined storage area is read and set as the style sheets for HTML mail whenever a new HTML mail is to be made.

Finally, regardless the monitoring result of the CSS conditions, after expiration of the predetermined waiting time (step S16), the series of processing starting from step S11 are repeated. It has been described hereinabove that the judgment is made if there is any change in the currently extracted CSS definition syntax from the previously extracted one in steps S14 and S15 and that the currently extracted CSS definition syntax is stored as information defining the updated style in a predetermined storage area only if any change is found. However, it is to be noted that the CSS definition syntax relating to the company's home page may be stored as the CSS definition syntax that defines the most recent style in a predetermined storage area whenever extracted regardless the change from the previously extracted CSS definition syntax.

Consequently, when making a new outgoing HTML mail, it is possible to acquire the updated CSS definition syntax from the predetermined storage area without performing the operation to acquire the most recent CSS definition syntax by gaining access to the company's home page (Web page) for disclosing outside the company. This means that the appearance of the outgoing HTML mails can be made to follow the most recent CI policy even if any change is made in the CI policy.

### Advantages of the Exemplary Embodiment

When the CSS acquisition means 32 performs the operation as illustrated in FIG. 7, it is possible to enjoy the first and third exemplary advantages that have been described hereinabove with reference to FIG. 6. Additionally, it exhibits the following new or fifth exemplary advantage.

The fifth exemplary advantage is to avoid worn out of the CSS definition syntax to be used in HTML mails and reduce processing loads when making new HTML mails as compared to the operation in FIG. 6, thereby enabling to smoothly make HTML mails. Because the acquisition processing of the CSS definition syntax is performed as a background job in FIG. 7, thereby reducing processing loads when making new HTML mails. In contrast, in case of the operation in FIG. 6, there are overheads for acquisition processing of the CSS definition syntax including the access to the company's home page (Web page) for disclosing outside the company whenever a new HTM mail is made.

While the invention has been particularly shown and described with reference to exemplary embodiments thereof, the invention is not limited to these embodiments. It will be understood by those of ordinary skill in the art that various changes in form and details may be made without departing from the spirit and scope of the present invention as defined by the appended claims. For example, the present invention may be implemented in the following exemplary embodiments (2)-(10) in addition to the exemplary embodiment (1) as mentioned hereinabove in the summary:

(2) A second exemplary embodiment of the HTML mail making system according to the invention (1) is to apply a predetermined standard template to the style of HTML mails if the CSS definition syntax that defines the style of the predetermined Web page does not exist or if failed to acquire the CSS definition syntax.

(3) A third exemplary embodiment of the HTML mail making system according to the invention (1) is to acquire the CSS definition syntax that defines the style of the predetermined Web page when making a new HTML mail and apply the acquired CSS definition syntax to the new HTML mail to be made.

(4) A fourth exemplary embodiment of the HTML making system according to the invention (1) is to periodically acquire at a predetermined period the CSS definition syntax that define the style of the predetermined Web page, store the acquired CSS definition syntax at a predetermined storage area, read out the CSS definition syntax stored in the storage area when making a new HTML mail and apply the read-out CSS definition syntax to the style of the new HTML mail to be made.

(5) Another exemplary aspect of the invention is an HTML mail making method for making an HTML mail using an HTML language including the steps of gaining access to a predetermined Web page, acquiring a CSS definition syntax that defines the style of the Web page, and applying the acquired CSS definition syntax to the style of the HTML mail to be made.

(6) A first exemplary embodiment of the HTML mail making method according to the invention (5) is to apply a predetermined template to the style of the HTML mail if the CSS definition syntax that defined the style of the predetermine Web page does not exist or if failed to acquire the CSS definition syntax.

(7) A second exemplary embodiment of the HTML mail making method according to the invention (5) is to acquire the CSS definition syntax that defines the style of the predetermined Web page when making a new HTML mail, and apply the acquired CSS definition syntax to the style of the new HTML mail to be made.

(8) A third exemplary embodiment of the HTML mail making method according to the invention (5) is to periodically acquire at a predetermined period the CSS definition syntax that defines the style of the predetermined Web page, store the acquired CSS definition syntax in a predetermined storage area, read out the CSS definition syntax stored in the storage area when making a new HTML mail, and apply the read out CSS definition syntax to the style of the new HTML mail to be made.

(9) A still another exemplary aspect of the invention is an HTML mail making program for implementing the THML mail making method of ether one of the above (5)-(8) in a program to be executed by a computer.

(10) A yet another aspect of the invention is a program recording medium for recording the HTML mail making program of the above (9) in a computer readable recording medium.

What is claimed is:

1. An HTML mail making system for enabling an operator (user) to make a mail having a uniform style, comprising:
a Web server under control of an organization (company) to whom the operator belongs and in which a Web page is carried; and
an information processing machine (PC) that is operated by the operator and that can be connected to the Web server by way of the internet;
wherein CSS data in the Web page is down loaded in the information processing machine for extracting the CSS definition syntax that defines the style of mail and the extracted CSS definition syntax is applied to the mail to be made by the operator on the information processing machine.

2. An HTML mail making system of claim 1, further comprising acquisition means for periodically acquiring the CSS definition syntax from the Web server at a predetermined period in order to update the style of mail.

3. An HTML mail making system of claim 2, further comprising storage means for storing the acquired CSS definition syntax in a predetermined storage area to be subsequently read out when making the mail.

4. An HTML mail making system of claim 1, further comprising default means for providing a predetermined standard template in case of non-existence of the CSS definition syntax or failure in acquiring the CSS definition syntax.

5. An HTML mail making method for making an HTML mail using an HTML (Hypertext Markup Language) language, comprising the steps of:
gaining access to a predetermined Web page;
acquiring CSS (Cascading Style Sheets) definition syntax that defines the style of the Web page; and
applying the acquired CSS definition syntax to the style of the HTML mail to be made.

6. An HTML mail making method of claim 5, wherein a predetermined standard template is applied to the style of the HTML mail to be made if the CSS definition syntax that defines the style of the predetermined Web mail does not exist or if failed to acquire the CSS definition syntax.

7. An HTML mail making method of claim 5, wherein the CSS definition syntax that defines the style of the predetermined Web page is acquired when making a new HTML mail and the acquired CSS definition syntax is applied to the style of the new HTML mail to be made.

8. An HTML mail making method of claim 5, wherein the CSS definition syntax that defines the style of the predetermined Web page is acquired periodically at a predetermined period, the acquired CSS definition syntax is stored in a predetermined storage area, and the CSS definition syntax stored in the predetermined storage area is read out when making a new HTML mail for application to the style of the new HTML mail to be made.

9. An HTML mail making program for implementing the HTML mail making method of claim 5 as a program that is executable by a computer.

10. A program recording medium for recording the HTML mail making program of claim 9 in a computer readable recording medium.
